(19) United States
(12) Patent Application Publication
(10) Pub. No.: US 2004/0128976 A1
(43) Pub. Date: Jul. 8, 2004

(54) Gas and steam power plant for water desalination

(76) Inventor: Eberhard Gralla, Adelsdorf (DE)

Correspondence Address: HARNESS, DICKEY & PIERCE, P.L.C., P.O.BOX 8910, RESTON, VA, 20195, US

(21) Appl. No.: 10/689,953

(22) Filed: Oct. 22, 2003

(30) Foreign Application Priority Data
Oct. 23, 2002 (EP) 02023801.0

(51) Int. Cl. F02C 6/00

(52) U.S. Cl. 60/39.182; 60/801

(57) ABSTRACT

In a gas and steam power plant for water desalination, a heat exchanger surface is arranged in the region of the cold end of a heat recovery boiler. This surface is provided for preheating the water to be desalinated.

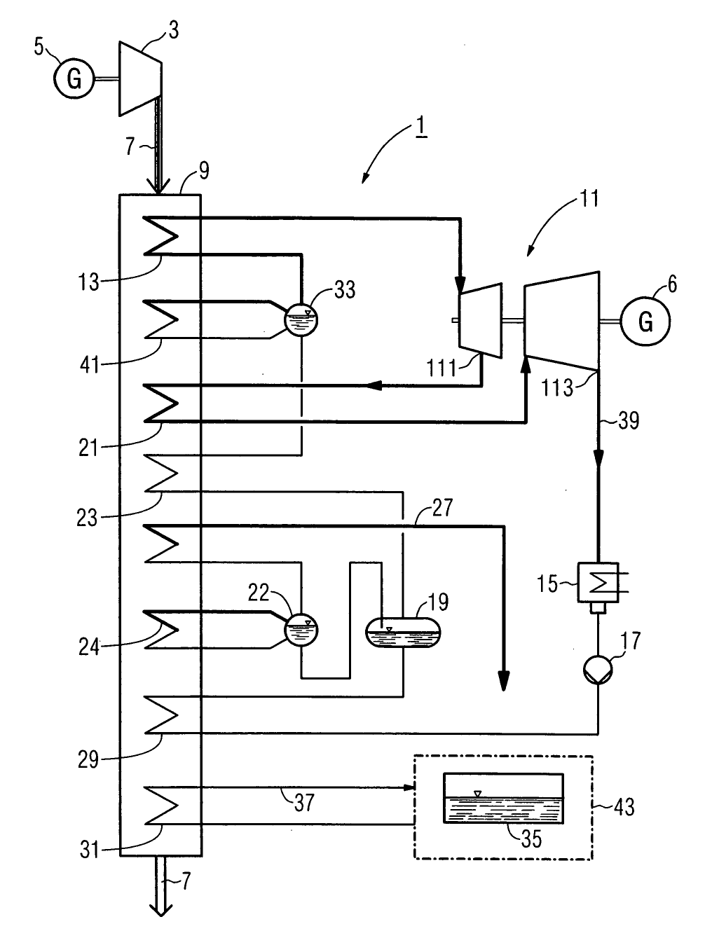

The present application hereby claims priority under 35 U.S.C. §119 on European patent application number EP 02023801.0 filed Oct. 23, 2002, the entire contents of which are hereby incorporated herein by reference.

### FIELD OF THE INVENTION

The invention generally relates to a gas and steam power plant for water desalination, in particular for sea water desalination.

### BACKGROUND OF THE INVENTION

To process water containing salt, for example into drinking and/or industrial water, it is necessary to desalinate the water as efficiently as possible. In particular in regions where there is a shortage of water and in which only sea water containing salt is available, the processing of sea water by desalination is often vital.

To this end, water must be heated—usually in several stages—in order to be able to largely separate the salt proportion. A relatively large quantity of energy is required for this purpose.

### SUMMARY OF THE INVENTION

An object of an embodiment of the invention is therefore to specify a gas and steam power plant for water desalination, by which the water desalination is possible with energy being utilized in an especially effective manner.

An object may be achieved according to an embodiment of the invention by a gas and steam power plant for water desalination. Such a plant includes a heat recovery boiler into which the hot exhaust gas from a gas turbine can be directed and by which process and/or auxiliary steam for a steam turbine can be generated by way of heat exchange by utilizing the heat energy contained in the exhaust gas. It further includes a heat exchanger surface being arranged in the region of the cold end of the heat recovery boiler, to which heat exchanger surface, for heating water to be desalinated, in particular sea water, at least a partial quantity of the water to be desalinated can be fed and can be heated by way of heat exchange with the exhaust gas.

In this case, an embodiment of the invention may be based on the idea that, in conventional gas and steam power plants, downstream of which a separate apparatus for the water desalination is arranged, the outlet temperature of the exhaust gas from the heat recovery boiler still contains sufficient heat energy in order to be able to at least preheat the water to be desalinated by means of the heat recovery boiler without having to resort to additional, external heat sources in the process.

Due to the process, the outlet temperature of the exhaust gas from the heat recovery boiler of known gas and steam power plants for water desalination with a downstream apparatus for the water desalination is approximately between 120° C. and 150° C.; such high outlet temperatures are mainly due to the relatively high temperature of the condensate which comes from the desalination plant and which accumulates during the water desalination by way of a known apparatus for the water desalination and is fed back into the gas and steam process.

By way of a gas and steam power plant according to an embodiment of the invention for water desalination, the high outlet temperatures of the exhaust gas from the boiler may now be utilized for heating the water to be desalinated. For this purpose, the heat exchanger surface according to an embodiment of an embodiment of the invention is provided.

As a result, it is possible, inter alia, to reduce the outlet temperature of the exhaust gas to the value of known gas and steam power plants without apparatus for sea water desalination, this value being about 80° C., the temperature difference of about 40° C. to 70° C. being used in the invention for heating the water to be desalinated.

The utilization of the heat energy contained in the exhaust gas is especially effective as a result.

In an advantageous configuration of an embodiment of the invention, the heat exchanger surface is the last heat exchanger surface in the heat recovery boiler in the direction of flow of the exhaust gas.

In this embodiment of the invention, by suitable design of the heat exchanger surface, provision may be made for the exhaust-gas temperature downstream of this heat exchanger surface, by the heat exchange with the heat exchanger surface, to be lowered to the advantageous exhaust-gas outlet temperature of about 80° C. desired in gas and steam power plants or to another desired value. The utilization of energy is then especially efficient.

The heat recovery boiler is advantageously fired.

The additional firing of the heat recovery boiler by a, in particular fossil, fuel permits, inter alia, accurate setting of the exhaust-gas temperature field in the heat recovery boiler. As a result, the heat recovery boiler, which as a rule includes a number of heat exchangers for generating process and/or auxiliary steam, can be operated at the desired temperature level with high efficiency. Furthermore, an increase in the generation of process and/or auxiliary steam is realized.

In a further advantageous configuration of an embodiment of the invention, the temperature of the exhaust gas before the heat exchange with the heat exchanger surface is within the range of between about 120° C. and 150° C.

This temperature range corresponds to the exhaust-gas outlet temperature of known gas and steam power plants for water desalination having a downstream, separate apparatus for the water desalination. It is thus possible to develop such known plants for the purposes of the invention in a simple manner by way of the heat exchanger surface according to the invention and at the same time increase the utilization of energy. The exhaust-gas temperature upstream of the heat exchanger surface according to an embodiment of the invention, is lowered by about 40° C. to 70° C. by the heat exchange with the heat exchanger surface according to the invention and this temperature difference being used for preheating the water to be desalinated.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention, and wherein:

The FIGURE shows a gas and steam power plant according to an embodiment of the invention for water desalination.

### DETAILED DESCRIPTION OF THE PREFERRED EMBODIMENTS

A gas and steam power plant 1 according to an embodiment of the invention for sea water desalination is shown schematically in the figure. The gas and steam power plant 1 includes a gas turbine 3 and a steam turbine 11 which are in each case coupled to a generator 5, 6 for generating electrical energy.

Exhaust gas 7 from the gas turbine 3 is directed into a heat recovery boiler 9 in particular for generating process and auxiliary steam for the steam turbine 11.

Expanded steam 39 collects during operation of the gas and steam power plants 1, and this expanded steam 39 leaves a low-pressure stage 113 of the steam turbine 11 and is directed to a condenser 15. The condensate processed there is fed by means of a condensate pump 17 to a condensate preheater 29 arranged in the heat recovery boiler 9 and is then directed as preheated condensate to a feed water tank 19. Feed water from the feed water tank 19 is heated by means of a feed water preheater 23 and is fed to a steam drum 33. The latter is connected to an evaporator 41. Steam is extracted from the steam drum 33 and fed to a high-pressure superheater 13, by which process steam is generated for a high-pressure stage 111 of the steam turbine 11.

Partly expanded steam from the high-pressure stage 111 is heated by means of a reheater 21 and fed to the low-pressure stage 113.

Feed water from the feed water tank 19 is fed to a low-pressure steam drum 22 which is connected to a low-pressure evaporator 24. Steam is extracted from the low-pressure steam drum 22 and fed to a low-pressure superheater 25, by which low-pressure steam 27 is generated for a plant 43 for the sea water desalination. The plant 43 includes a reservoir 35 for sea water to be desalinated. Sea water is extracted from this reservoir 35 and fed to a heat exchanger surface 31, which is arranged in the region of the cold end of the heat recovery boiler. By means of this heat exchanger surface 31, the sea water is preheated and fed back as preheated sea water 37 to the plant 43 for further treatment.

A separate heat source for preheating the sea water to be desalinated is unnecessary; provided for this purpose in an embodiment of the invention is the heat exchanger surface 31, by which the quantity of heat contained in the exhaust gas 7 is used for preheating the sea water. A temperature difference of about 40° C. to 70° C. is available for this purpose.

Instead of being passed directly into the condenser 15, the expanded steam 39 may also be directed in the uncondensed state to the plant 43 and used there; in this case, a condenser may be provided inside the plant 43.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A gas and steam power plant for water desalination, comprising:
a heat recovery boiler into which hot exhaust gas from a gas turbine is directable and by which at least one of process and auxiliary steam for a steam turbine is adapted to be generated by heat exchange utilizing heat energy contained in the exhaust gas, wherein a heat exchanger surface is arranged in the region of a cold end of the heat recovery boiler and for heating water to be desalinated, is adapted to receive at least a partial quantity of the water to be desalinated and is adapted to be heated by heat exchange with the exhaust gas.

2. The gas and steam power plant as claimed in claim 1, wherein the heat exchanger surface is a last heat exchanger surface in the heat recovery boiler in the direction of flow of the exhaust gas.

3. The gas and steam power plant as claimed in claim 1, wherein the outlet temperature of the exhaust gas from the heat recovery boiler is about 80° C.

4. The gas and steam power plant as claimed in claim 1, wherein the heat recovery boiler is fired.

5. The gas and steam power plant as claimed in claim 1, wherein the temperature of the exhaust gas before the heat exchange with the heat exchanger surface is within the range of between about 120° C. and 150° C.

6. The gas and steam power plant as claimed in claim 1, wherein the water to be desalinated is sea water.

7. The gas and steam power plant as claimed in claim 2, wherein the outlet temperature of the exhaust gas from the heat recovery boiler is about 80° C.

8. The gas and steam power plant as claimed in claim 2, wherein the heat recovery boiler is fired.

9. The gas and steam power plant as claimed in claim 3, wherein the heat recovery boiler is fired.

10. The gas and steam power plant as claimed in claim 7, wherein the heat recovery boiler is fired.

11. The gas and steam power plant as claimed in claim 2, wherein the temperature of the exhaust gas before the heat exchange with the heat exchanger surface is within the range of between about 120° C. and 150° C.

12. The gas and steam power plant as claimed in claim 3, wherein the temperature of the exhaust gas before the heat exchange with the heat exchanger surface is within the range of between about 120° C. and 150° C.

13. The gas and steam power plant as claimed in claim 4, wherein the temperature of the exhaust gas before the heat exchange with the heat exchanger surface is within the range of between about 120° C. and 150° C.

14. The gas and steam power plant as claimed in claim 7, wherein the temperature of the exhaust gas before the heat exchange with the heat exchanger surface is within the range of between about 120° C. and 150° C.

15. The gas and steam power plant as claimed in claim 8, wherein the temperature of the exhaust gas before the heat exchange with the heat exchanger surface is within the range of between about 120° C. and 150° C.

16. The gas and steam power plant as claimed in claim 9, wherein the temperature of the exhaust gas before the heat exchange with the heat exchanger surface is within the range of between about 120° C. and 150° C.

17. The gas and steam power plant as claimed in claim 10, wherein the temperature of the exhaust gas before the heat exchange with the heat exchanger surface is within the range of between about 120° C. and 150° C.

18. A system for water desalination, comprising:
means for receiving hot exhaust gas from a gas turbine and for generating, by heat exchange utilizing heat energy contained in the exhaust gas, at least one of process and auxiliary steam for a steam turbine, wherein a relatively cold end of the means is adapted to receive at least a partial quantity of the water to be desalinated and is adapted to heat the water by heat exchange with the exhaust gas.

19. The system as claimed in claim 18, wherein the relatively cold end of the means includes a last heat exchanger surface in the means, in a direction of flow of the exhaust gas.

20. The system as claimed in claim 18, wherein an outlet temperature of the exhaust gas from the means is about 80° C.

21. The system as claimed in claim 18, wherein the means is fired.

22. The system as claimed in claim 18, wherein a temperature of the exhaust gas before the heat exchange with the heat exchanger surface is within the range of between about 120° C. and 150° C.

23. The system as claimed in claim 18, wherein the water to be desalinated is sea water.
